(19) United States
(12) Patent Application Publication
(10) Pub. No.: US 2016/0368035 A1
(43) Pub. Date: Dec. 22, 2016

(54) COPPER ALLOY TWISTED WIRE, METHOD FOR MANUFACTURING SAME, AND ELECTRIC WIRE FOR AUTOMOBILE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Hiroyuki KOBAYASHI, Yokkaichi, Mie (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 15/122,225

(22) PCT Filed: Feb. 11, 2015
(86) PCT No.: PCT/JP2015/053714

§ 371 Date: Aug. 29, 2016

(30) Foreign Application Priority Data
Feb. 28, 2014 (JP) 2014-038588

(51) Int. Cl. B21C 1/02; C22C 9/00; H01B 13/02; B60R 16/02; H01B 1/02; H01B 13/00; C22F 1/08; B21C 1/00

(52) U.S. Cl. CPC B21C 1/02; C22F 1/08; C22C 9/00; B21C 1/003; B60R 16/02; H01B 1/026; H01B 13/0016; H01B 13/02

(57) ABSTRACT

A cast material is formed, the cast material having a chemical component composition that contains at least one additional element selected from the group consisting of Fe, Ti, Sn, Ag, Mg, Zn, Cr, and P in an amount of at least 1.0 mass % and not more than 2.0 mass % in total, and in which a remaining portion includes Cu and inevitable impurities. An expanded material is formed by subjecting the cast material to plastic forming. An intermediate wire material is formed by wiredrawing the expanded material. The intermediate wire material is annealed. A single wire is formed by wiredrawing the annealed intermediate wire material at a cold deformation degree in a range of at least 77% and less than 99%. A twisted wire is formed by twisting a plurality of single wires, and the twisted wire is heated. Accordingly, a copper alloy twisted wire is obtained.

### CROSS REFERENCE TO RELATED APPLICATIONS

This application claims the priority of Japanese patent application JP2014-038588 filed on Feb. 28, 2014, the entire contents of which are incorporated herein.

### Technical Field

The present invention relates to a copper alloy twisted wire, a method for manufacturing the same, and an electric wire for an automobile, and more specifically relates to a copper alloy twisted wire for use as a conductor of an electric wire for an automobile, a method for manufacturing the same, and an electric wire for an automobile.

### Background Art

Conventionally, an electric wire for an automobile having a conductor and an insulator with which an outer circumference of the conductor is coated is known. In general, a copper alloy twisted wire obtained by twisting a plurality of single wires made of a copper alloy is used as the above-described conductor.

In recent years, following a reduction in the weight of automobiles, there is a demand for a reduction in the weight of the electric wires in an automobile. Reducing the diameter of a conductor is known as one of the methods for reducing the weight of electric wires in an automobile.

For example, Patent Document 1 (JP2008-16284A) discloses a method for manufacturing a copper alloy twisted wire for use as a conductor of an electric wire for an automobile and whose cross section is not more than 0.22 mm². The method for manufacturing this copper alloy twisted wire includes a step of forming a single wire by wiredrawing a copper alloy material that contains additional elements such as Mg, Ag, Sn, and Zn in an amount of less than 1 mass %, at a cold deformation degree of at least 99%, and a step of preparing a twisted wire by twisting a plurality of the obtained hard single wires.

### SUMMARY OF INVENTION

However, there is still room for improvement of the conventional technique on the following points. That is, if the diameter of a conductor is reduced, the diameter of one single wire that constitutes the conductor is reduced. Therefore, the strength of the conductor decreases. In order to avoid a decrease in the strength of a conductor, there is also the method of increasing the content of additional elements that are added to the copper alloy. However, if the content of additional elements is at least 1 mass % in total, the workability of the copper alloy material significantly decreases.

Therefore, with the conventional method of manufacturing a copper alloy twisted wire, wire drawability is ensured by using a copper alloy material that contains additional elements in an amount of less than 1 mass %. Also, with the conventional method for manufacturing a copper alloy twisted wire, an increase in the strength of a single wire is achieved by wiredrawing the copper alloy material at a cold deformation degree of at least 99%. Moreover, with the conventional method for manufacturing a copper alloy twisted wire, an increase in the strength of a copper alloy twisted wire obtained by twisting a plurality of hard single wires with assured strength to prepare a twisted wire is achieved.

However, since in the conventional method for manufacturing a copper alloy twisted wire, hard single wires are twisted, the wires may have low wire twistability, and it may not be possible to twist the wires. Also, even if it is possible to twist the wires, the wires tend to be broken rather easily during twisting. And although the obtained copper alloy twisted wire has strength, it has low elongation.

The present design has been achieved in light of the above-described circumstances, and is to provide a method for manufacturing a copper alloy twisted wire having good strength and elongation, with which the number of instances of breakage during twisting can be suppressed, and is to provide a copper alloy twisted wire having good strength and elongation, with a small number of instances of breakage caused by wire twisting.

An aspect of the present invention is a method for manufacturing a copper alloy twisted wire for use as a conductor of an electric wire for an automobile, the method including:

a step of forming a cast material having a chemical component composition that contains at least one additional element selected from the group consisting of Fe, Ti, Sn, Ag, Mg, Zn, Cr, and Pin an amount of at least 1.0 mass % and not more than 2.0 mass % in total, and in which a remaining portion includes Cu and inevitable impurities;

a step of forming an expanded material by subjecting the cast material to plastic forming;

a step of forming an intermediate wire material by wiredrawing the expanded material;

a step of annealing the intermediate wire material; a step of forming a single wire by wiredrawing the annealed intermediate wire material at a cold deformation degree in a range of at least 77% and less than 99%; and

a step of forming a twisted wire by twisting a plurality of the single wires and heating the twisted wire, or heating the single wire and forming a twisted wire by twisting a plurality of the heated single wires.

Another aspect of the present invention is a copper alloy twisted wire obtained by the method for manufacturing a copper alloy twisted wire, in which

a tensile strength is at least 450 MPa and an elongation is at least 5%.

Still another aspect of the present invention is an electric wire for an automobile, the electric wire including the copper alloy twisted wire and an insulator with which an outer circumference of the copper alloy twisted wire is coated.

The method for manufacturing a copper alloy twisted wire has the above-described steps. Therefore, according to this method for manufacturing a copper alloy twisted wire, it is possible to obtain a copper alloy twisted wire constituted by soft single wires having a specific chemical component composition that contains the above-described specific additional elements in a specific range. Therefore, with this method for manufacturing a copper alloy twisted wire, it is possible to manufacture a copper alloy twisted wire having good strength and elongation.

Moreover, in the method for manufacturing a copper alloy twisted wire, since the intermediate wire material is annealed, the influence of work hardening caused by wiredrawing or the like before annealing is lessened, and a softened intermediate wire material can be obtained. Also, with this method for manufacturing a copper alloy twisted wire, a single wire is obtained by wiredrawing the annealed intermediate wire material at a cold deformation degree in a range of at least 77% and less than 99%. Therefore, according to this method for manufacturing a copper alloy twisted wire, compared to the case where the intermediate wire material is not annealed, it is possible to obtain a single wire in which the influence of work hardening is lessened. In the method for manufacturing a copper alloy twisted wire, a plurality of the single wires are twisted to form a twisted wire, and the twisted wire is heated, or the single wire is heated, and a plurality of the heated single wires are twisted to form a twisted wire. Therefore, the method for manufacturing a copper alloy twisted wire makes it possible to suppress the number of instances of breakage during twisting.

Therefore, with this method for manufacturing a copper alloy twisted wire, it is possible to suppress the number of instances of breakage during twisting, and to manufacture a copper alloy twisted wire having good strength and elongation.

A copper alloy twisted wire can be manufactured using the method for manufacturing a copper alloy twisted wire. Therefore, the copper alloy twisted wire has good strength and elongation, with a small number of instances of breakage caused by wire twisting.

Since the electric wire for an automobile includes the copper alloy twisted wire, it has good strength and elongation, with a small number of instances of breakage caused by wire twisting.

### BRIEF DESCRIPTION OF DRAWINGS

FIG. 1 is an illustrative diagram showing a configuration of an electric wire for an automobile in which a copper alloy twisted wire manufactured by a method for manufacturing a copper alloy twisted wire according to Embodiment 1 is used.

FIG. 2 is an illustrative diagram showing a configuration of an electric wire for an automobile in which another copper alloy twisted wire manufactured by the method for manufacturing a copper alloy twisted wire according to Embodiment 1 is used.

### DESCRIPTION OF EMBODIMENTS

The method for manufacturing a copper alloy twisted wire includes a step of forming a cast material having a specific chemical component composition. Hereinafter, the reason why there is limitation on the chemical component composition will be described.

At least one additional element selected from the group consisting of Fe, Ti, Sn, Ag, Mg, Zn, Cr, and P: at least 1.0 mass % and not more than 2.0 mass % in total

Each of the above-described additional elements is an element effective to increase the strength of a single wire made of a copper alloy. In order to obtain the effect, the above-described additional elements need to be included in an amount of at least 1.0 mass % in total. From the viewpoint of balance between the strength and the electrical conductivity and the like, the above-described additional elements are included in an amount of preferably at least 1.05 mass % in total, and more preferably at least 1.1 mass % in total. On the other hand, if the above-described additional elements are included excessively, wire drawability and electrical conductivity will decrease.

Therefore, the above-described additional elements need to be limited to not more than 2.0 mass % in total. From the viewpoint of balance between the strength and the electrical conductivity, the above-described additional elements are included in an amount of preferably not more than 1.9 mass % in total, more preferably not more than 1.8 mass % in total, and even more preferably not more than 1.7 mass % in total. Fe, Ti, Sn, Mg, and Cr of the above-described additional elements are useful because they have a great effect of increasing the strength when added.

In the above-described chemical component composition, it is preferable that the O (oxygen) content is limited to not more than 20 ppm in mass ratio. The generation of oxides with other additional elements, such as titanium oxide (TiO₂) and tin oxide (SnO₂) can be suppressed by limiting the O content in the above-described range. As a result, a decrease in wire drawability and a decrease in strength are easily suppressed. The O content is more preferably not more than 15 ppm in mass ratio, and even more preferably not more than 10 ppm in mass ratio.

A cast material having the above-described chemical component composition can be formed by dissolving an electrolytic copper and a master alloy made of copper and additional elements and introducing a reducing agent such as reducing gas or wood to produce oxygen-free copper molten metal with the above-described chemical component composition intended, and then casting this molten metal, for example.

Any casting method such as continuous casting with a movable mold or a fixed mold having a frame shape, or metal mold casting with a fixed mold having a box shape can be used for casting. In particular, molten metal can be rapidly solidified, and additional elements can be dissolved in a solid solution in continuous casting. Therefore, there is the advantage that the subsequent solution heat treatment can be omitted.

The method for manufacturing a copper alloy twisted wire includes a step of forming an expanded material by subjecting a cast material to plastic forming (plastic working).

For example, hot rolling or cold rolling, extrusion, or the like can be adopted as plastic forming. If the cast material is manufactured with a method other than continuous casting, it is preferable to perform a solution heat treatment before or after, or before and after plastic forming. Note that the solution heat treatment may be performed under conditions where the temperature is kept at at least 800° C. and not more than 1050° C., for at least 0.1 hours and not more than 2 hours, for example.

The method for manufacturing a copper alloy twisted wire includes a step of forming an intermediate wire material by wiredrawing an expanded material.

The cold deformation degree when the intermediate wire material is formed from the expanded material can be selected as appropriate to achieve a wire diameter optimal for forming a single wire having a desired wire diameter from the intermediate wire material in the subsequent process. Note that wiredrawing can be performed once or repeatedly performed twice or more.

The method for manufacturing a copper alloy twisted wire includes a step of annealing the intermediate wire material.

This annealing is useful for reducing the influences of the work hardening caused by the plastic forming or wiredrawing until the intermediate wire material is formed, and softening the intermediate wire material. In particular, in the method for manufacturing a copper alloy twisted wire, a cast material having a chemical component composition in which the total content of the additional elements is as high as at least 1.0 mass % is used. Therefore, if an intermediate wire material that is not subjected to annealing is used, the subsequent wire drawability and wire twistability will decrease. However, in the method for manufacturing a copper alloy twisted wire, since the intermediate wire material is annealed, the subsequent wire drawability, and wire twistability can be improved.

The annealing temperature may be, specifically, in a range of 350° C. to 850° C., and may be preferably in a range of 450° C. to 800° C. Also, the annealing time may be, specifically, in a range of 0.01 seconds to 2 hours, and may be more preferably in a range of 0.05 seconds to 1 hour. An annealing atmosphere may be a nonoxidative atmosphere such as vacuum, inert gas (nitrogen, argon), or reducing gas (hydrogen-containing gas, carbon dioxide gas-containing gas). This is because the heat at the time of annealing tends to suppress an increase in oxide film on the surface of a copper alloy and an increase in contact resistance in the terminal connection portions.

Note that either batchwise annealing or continuous annealing may be adopted. An example of batchwise annealing includes a heating furnace method. Examples of the continuous annealing include resistive heating, induction-resistive heating, high frequency induction heating, and continuous heating using a tubular furnace with open upper and lower portions. The annealing temperature in continuous annealing may be set higher than the annealing temperature in batchwise annealing. Specifically, the annealing temperature in continuous annealing may be 450° C. to 850° C., for example. The annealing temperature in batchwise annealing may be 350° C. to 600° C., for example. Also, the annealing time in continuous annealing may be set shorter than the annealing temperature in batchwise annealing. The annealing time in continuous annealing may be 0.01 seconds to 0.5 hours, for example. The annealing time in batchwise annealing may be 0.5 hours to 2 hours, for example. Continuous annealing is advantageous in that characteristic variations in the longitudinal direction caused by annealing are easily suppressed and the productivity can be increased.

The method for manufacturing a copper alloy twisted wire includes a step of forming a single wire by wiredrawing the annealed intermediate wire material at a cold deformation degree in a range of at least 77% and less than 99%.

If the cold deformation degree is at least 99%, the number of instances of breakage when twisting a wire having a length of 10 km sharply increases, and it become difficult to suppress the number of instances of breakage. The productivity also deteriorates. From the viewpoint of the suppression of the number of instances of breakage during twisting and the improvement of the productivity, the cold deformation degree is preferably not more than 98.5%, more preferably not more than 98%, and even more preferably not more than 97.5%. On the other hand, if the cold deformation degree is less than 77%, it is difficult to obtain a single wire having a narrow diameter from which a copper alloy twisted wire whose cross section is not more than 0.22 mm² can be formed. From the viewpoint of narrowing the diameter of a single wire, the cold deformation degree may be preferably at least 80%, more preferably at least 82%, and even more preferably at least 85%. Note that the cold deformation degree described above can be calculated by 100×(the cross section of an intermediate wire material the cross section of a single wire)/(the cross section of the intermediate wire material). Wiredrawing for forming a single wire can be performed once or repeatedly performed twice or more.

The diameter of the single wire may be not more than 0.3 mm. Accordingly, the cross section of a copper alloy twisted wire can be relatively easily reduced. From the viewpoint of narrowing the diameter and reducing the weight, the diameter of the single wire may be preferably not more than 0.25 mm, and more preferably not more than 0.20 mm. Also, from the viewpoint of assuring the strength of a copper alloy twisted wire, a reduction in the above-described number of instances of breakage, the productivity of a single wire, and the like, the diameter of the single wire may be preferably at least 0.10 mm.

The above-described method for manufacturing a copper alloy twisted wire includes a step of forming a twisted wire by twisting a plurality of single wires and heating the twisted wire, or heating a single wire and forming a twisted wire by twisting a plurality of the heated single wires.

Heating in this step is useful for softening the twisted wire and assuring the elongation while maintaining the strength of the twisted wire. In this step, it is possible to heat a single wire, form a twisted wire by twisting a plurality of the heated single wires, and heating the twisted wire. In this case, because the elongation of the twisted wire can be further improved, it is possible to manufacture a copper alloy twisted wire with excellent elongation characteristics. Also, in this step, the twisted wire can be subjected to compression molding.

Specifically, heating can be performed under conditions where the tensile strength of the obtained copper alloy twisted wire is at least 450 MPa and the elongation is at least 5%.

Specifically, the heating temperature may be in a range of 300° C. to 600° C., and preferably in a range of 350° C. to 550° C. Also, the heating time may be, specifically, in a range of 0.01 seconds to 9 hours, and preferably in a range of 0.05 seconds to 8 hours, for example. Also, the heating atmosphere and the heating method are similar to those described for the annealing, so that their further description is omitted.

The heating temperature in continuous heating may be 450° C. to 850° C., for example. The heating temperature in batchwise heating may be 350° C. to 600° C., for example. Also, the heating time in continuous heating may be 0.01 seconds to 0.5 hours, for example. The heating time in batchwise heating may be 0.5 hours to 2 hours, for example. Continuous heating is advantageous in that characteristic variations in the longitudinal direction caused by heating are easily suppressed and the productivity can be increased.

The method for manufacturing a copper alloy twisted wire is particularly suitable as a method for manufacturing a copper alloy twisted wire having a narrow diameter whose cross section is not more than 0.22 mm². This is because the functional effect of the method for manufacturing a copper alloy twisted wire is sufficiently exhibited. Note that from the viewpoint of narrowing the diameter and reducing the weight, the cross section of the twisted wire is preferably not more than 0.17 mm², and more preferably not more than 0.13 mm². Also, from the viewpoint of assuring the strength of a copper alloy twisted wire, a reduction in the number of instances of breakage, the productivity of copper alloy twisted wires, and the like, the cross section of the twisted wire may be preferably at least 0.05 mm², and more preferably at least 0.08 mm².

A copper alloy twisted wire is obtained with the method for manufacturing a copper alloy twisted wire. A tensile strength of the copper alloy twisted wire is at least 450 MPa and its elongation is at least 5%. Accordingly, if the cross section of the twisted wire is not more than 0.22 mm², its impact resistance can be assured. Therefore, an electric wire for an automobile with excellent workability of assembling a wire harness can be easily realized. Also, even if the cross section of a twisted wire is not more than 0.22 mm², an electric wire for an automobile with excellent fixing strength when fixed to a terminal is easily realized due to the fact that the tensile strength is at least 450 MPa.

Note that the above-described tensile strength may be preferably at least 480 MPa, and more preferably at least 500 MPa. Also, from the viewpoint of balance between the tensile strength and the conductivity, the above-described tensile strength may be preferably not more than 570 MPa. Also, the above-described elongation is preferably at least 7%, and more preferably at least 10%. Also, from the viewpoint of balance between the elongation and the strength of a conductor, the above-described elongation may be preferably not more than 15%.

The copper alloy twisted wire may have an electrical conductivity of at least 62% IACS. Accordingly, an electric wire for an automobile whose cross section is not more than 0.22 mm² is easily realized. Also, this electric wire for an automobile can be used suitably as a signal wire.

The above-described electric wire for an automobile includes the above-described copper alloy twisted wire and an insulator with which the outer circumference of this copper alloy twisted wire is coated. The insulator can be made of an electrically insulative resin composition containing a polymer such as various resins and rubbers (including elastomer) as the main component. The above-described resins and rubbers can be used alone or in combination. Specifically, representative examples of the above-described polymer include vinyl chloride-based resin, polyolefin-based resin, and polysulfone-based resin. The insulator may be constituted by one layer, or may be constituted by two or more layers. The thickness of the insulator may be at least 0.1 mm and not more than 0.4 mm, for example. Note that the insulator may contain one or more various additive agents that are usually utilized in an electric wire. Specifically, representative examples of the above-described additive agents include a filler, a flame retardant, an antioxidant, an anti-aging agent, a lubricant, a plasticizer, a copper inhibitor, and a pigment.

Note that in order to obtain the above-described functional effects or the like, the above-described configurations may be used in combination as needed.

Working Examples

Working examples of the above-described copper alloy twisted wire, the method for manufacturing the same, and an electric wire for an automobile will be described along with a comparative example.

### Working Example 1

In this example, copper alloy twisted wires were produced by twisting seven single wires made of a copper alloy and having a chemical component composition shown in Table 1, which were then evaluated.

The copper alloy twisted wires were produced by performing a step of forming a cast material having a chemical component composition that contains at least one additional element selected from the group consisting of Fe, Ti, Sn, Ag, Mg, Zn, Cr, and P in a total amount of at least 1.0 mass % and not more than 2.0 mass % and in which a remaining portion includes Cu and inevitable impurities, a step of forming an expanded material by subjecting the cast material to plastic forming, a step of forming an intermediate wire material by wiredrawing the expanded material, a step of annealing the intermediate wire material, a step of forming a single wire by wiredrawing the annealed intermediate wire material at a cold deformation degree in a range of at least 77% and less than 99%, and a step of forming a twisted wire by twisting a plurality of the single wires and heating the twisted wire, or heating the single wire and forming a twisted wire by twisting a plurality of the heated single wires.

Specifically, the copper alloy twisted wire was produced as follows. That is, a mixed molten metal having a chemical component composition shown in Table 1 was produced by introducing an electrolytic copper with at least 99.99% purity and a master alloy containing copper and additional elements in a crucible made of highly pure carbon, and subjecting the mixture to vacuum melting in a continuous casting apparatus. Thereafter, the obtained mixed molten metal was subjected to continuous casting using a mold with highly pure carbon, and a cast material having a circular cross section having a diameter of ø12.5 mm was formed.

Next, an expanded material was formed by swaging the obtained cast material down to ø8 mm. In this example, the swaged expanded material was subjected to a solution heat treatment under the condition that the temperature was kept at 950° C. for one hour.

Next, an intermediate wire material was formed by wiredrawing the obtained expanded material down to ø0.45 mm to ø1.2 mm.

Next, the obtained intermediate wire material was annealed under annealing conditions shown in Table 2.

Next, a single wire having a diameter of ø0.215 mm or ø0.16 mm was formed by wiredrawing the annealed intermediate wire material at the cold deformation degree shown in Table 1.

Next, a twisted wire was formed by twisting the obtained seven single wires at a twisting pitch of 16 mm. At that time, the number of instances of breakage occurring when twisting a wire having a length of 10 km was determined. Also, the formed twisted wire was heated under heating conditions shown in Table 2. Accordingly, copper alloy twisted wires of Sample 1 to Sample 6, and Sample C101 were obtained. Note that Sample C102 was obtained by forming a single wire without annealing in the production of the copper alloy twisted wire. However, no subsequent wire twisting was performed.

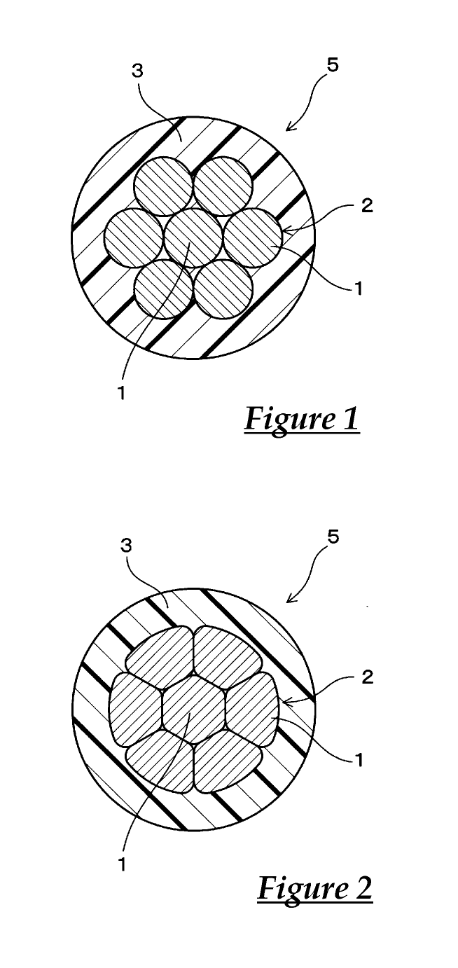

Next, the outer circumferences of conductors made of the copper alloy twisted wires of Sample 1 to Sample 6 were coated with polyvinyl chloride (PVC) as an insulator by extrusion in a thickness of 0.2 mm. Accordingly, electric wires for an automobile of Samples 1-1 to 1-6 were obtained. As shown in FIG. 1, the obtained electric wire 5 for an automobile has a copper alloy twisted wire 2 in a state in which seven single wires 1 made of a copper alloy were twisted, and an insulator 3 with which the outer circumference of this copper alloy twisted wire 2 was coated. Note that as shown in FIG. 2, a configuration is also possible in which the electric wire 5 for an automobile has a copper alloy twisted wire 2 obtained by twisting and circularly compressing seven single wires 1 made of a copper alloy in the radial direction of the twisted wire, and the insulator 3 with which the outer circumference of this copper alloy twisted wire 2 was coated.

The characteristics of the copper alloy twisted wires obtained in this example were evaluated as follows. First, tensile testing was performed under the conditions that a gauge length GL is 250 mm and a tensile speed is 50 mm/min, and a tensile strength (MPa) and elongation (%) were measured. Also, the electrical resistance of a gauge length GL of 1000 mm was measured to calculate electrical conductivity (% IACS). The obtained results are shown in Table 2.

TABLE 1

| | | | | | | | | | | | | | | Twisted wire | |
|---|---|---|---|---|---|---|---|---|---|---|---|---|---|---|---|
| | | | | | | | | | | | | | | | No. of |
| | | | | | | | | | | | | | | | instances |
| | Chemical component composition | | | | | | | | | | | | | | of |
| | mass % | | | | | | | | | | | | | twisted | breakage |
| | | | | | | | | | | Total | ppm | Single wire | | wire | when |
| | | | | | | | | | | amount of | (mass | cold | wire | cross | twisting |
| Sample | | | | | | | | | | additional | ratio) | deformation | diameter | section | 10 km- |
| No. | Cu | Fe | Ti | Sn | Ag | Mg | Zn | Cr | P | elements | O | degree (%) | (mm) | (mm²) | wire |
| 1 | Bal. | — | — | — | — | 0.91 | — | — | 0.10 | 1.01 | 9 | 77.2 | 0.215 | 0.22 | 1 |
| 2 | Bal. | — | — | — | — | 0.91 | — | — | 0.10 | 1.01 | 9 | 87.3 | 0.160 | 0.13 | 1 |
| 3 | Bal. | 0.94 | 0.18 | — | — | 0.03 | — | — | 0.10 | 1.25 | 8 | 87.3 | 0.160 | 0.13 | 0 |
| 4 | Bal. | 0.94 | 0.18 | — | — | 0.03 | — | — | — | 1.15 | 8 | 96.0 | 0.160 | 0.13 | 0 |
| 5 | Bal. | 0.94 | 0.18 | — | — | 0.03 | — | — | — | 1.15 | 8 | 97.4 | 0.160 | 0.13 | 0 |
| 6 | Bal. | — | — | 0.28 | 0.01 | — | 0.10 | 1.2 | — | 1.59 | 4 | 98.2 | 0.160 | 0.13 | 0 |
| C101 | Bal. | 0.94 | 0.18 | — | — | — | — | — | — | 1.12 | 10 | 99.96 | 0.160 | 0.13 | 5 |

| | | | | | | | | | | | | | | |
|---|---|---|---|---|---|---|---|---|---|---|---|---|---|---|
| C102 | Bal. | 0.94 | 0.18 | — | — | 0.03 | — | — | — | 1.15 | 50 | 99.6 | 0.160 | was not twisted |

TABLE 2

| | | | | | | | | | Characteristics | | |
|---|---|---|---|---|---|---|---|---|---|---|---|
| | | | | | | | | | tensile | | electrical |
| Sample | Annealing conditions | | | | Heating conditions | | | | strength | elongation | conductivity |
| No. | Method | temp. (° C.) | time | | method | temp. (° C.) | time | | (MPa) | (%) | (% IACS) |
| 1 | Batch | 450 | 1 | h | continuous | 500 | 0.1 | sec | 490 | 7 | 62 |
| 2 | Batch | 450 | 1 | h | batch | 300 | 8 | h | 551 | 8 | 63 |
| 3 | continuous | 800 | 0.1 | sec | batch | 500 | 8 | h | 554 | 10 | 64 |
| 4 | continuous | 800 | 0.1 | sec | batch | 500 | 4 | h | 503 | 11 | 66 |
| 5 | continuous | 800 | 0.1 | sec | batch | 450 | 8 | h | 518 | 10 | 68 |
| 6 | continuous | 800 | 0.1 | sec | batch | 360 | 4 | h | 570 | 11 | 72 |
| C101 | continuous | 800 | 0.1 | sec | batch | 450 | 8 | h | 564 | 10 | 69 |

| | | | | | | | |
|---|---|---|---|---|---|---|---|
| C102 | no annealing | — | — | — | — | — | — |

According to Table 1 and Table 2, the following can be understood. That is, a cast material made of a copper alloy containing additional elements in a total amount of greater than 1 mass % is used to produce Sample C102. Nevertheless, the single wire is formed without annealing the intermediate wire material in the production of Sample C102. Therefore, in the production of Sample C102, the intermediate wire material had low wire twistability, and a twisted wire could not be formed.

Also, a cast material made of a copper alloy containing additional elements in a total amount of greater than 1 mass % is used in the production of Sample C101. Nevertheless, a single wire is formed by wiredrawing the annealed intermediate wire material at a cold deformation degree of at least 99% in the production of Sample C101. Therefore, breakage in the twisted wire was remarkable during twisting in the production of Sample C101. As a result, a copper alloy twisted wire that is unlikely to be broken and has good strength and elongation was not obtained.

In contrast, in the production of Sample 1 to Sample 6, copper alloy twisted wires are produced through the steps defined above. Therefore, the number of instances of breakage during twisting was suppressed. Also, a copper alloy twisted wire that is unlikely to be broken by wire twisting and has good strength and elongation was obtained. Also, it was confirmed that although the obtained copper alloy twisted wires had high strength, they had an electrical conductivity of at least 62% IACS, and their strength was improved without impairing their electrical conductivity.

Although the working examples have been described in detail above, the present invention is not merely limited to the above-described working examples, and various modifications can be made without departing from the gist of the present invention.

1. A copper alloy twisted wire obtained by a method for manufacturing a copper alloy twisted wire, the method comprising:
a step of forming a cast material having a chemical component composition that contains at least one additional element selected from the group consisting of Fe, Ti, Sn, Ag, Mg, Zn, Cr, and P in an amount of at least 1.0 mass % and not more than 2.0 mass % in total, and in which a remaining portion includes Cu and inevitable impurities;
a step of forming an expanded material by subjecting the cast material to plastic forming;
a step of forming an intermediate wire material by wiredrawing the expanded material;
a step of annealing the intermediate wire material;
a step of forming a single wire by wiredrawing the annealed intermediate wire material at a cold deformation degree in a range of at least 77% and less than 99%; and
a step of forming a twisted wire by twisting a plurality of the single wires and heating the twisted wire, or heating the single wire and forming a twisted wire by twisting a plurality of the heated single wires;
the copper alloy twisted wire being for use as a conductor of an electric wire for an automobile, and having a tensile strength of at least 450 MPa and an elongation of at least 5%

2. The copper alloy twisted wire according to claim 1, wherein an electrical conductivity is at least 62% IACS.

3. The copper alloy twisted wire according to claim 1, wherein the chemical component composition of the cast material contains O in an amount of not more than 20 ppm in mass ratio.

4. The copper alloy twisted wire according to claim 1, wherein a diameter of the single wire is not more than 0.3 mm.

5. The copper alloy twisted wire according to claim 1, wherein a cross section of the twisted wire is not more than 0.22 mm².

6. An electric wire for an automobile, comprising:
the copper alloy twisted wire according to claim 1; and
an insulator with which an outer circumference of the copper alloy twisted wire is coated.

7. (canceled)
